(19) United States
(12) Patent Application Publication
(10) Pub. No.: US 2004/0073924 A1
(43) Pub. Date: Apr. 15, 2004

(54) Broadcast scheduling and content selection based upon aggregated user profile information

(76) Inventor: Ramesh Pendakur, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/262,433

(22) Filed: Sep. 30, 2002

(51) Int. Cl. H04N 7/16; H04H 9/00; H04N 7/025; H04N 7/10; G06F 13/00; H04N 5/445; G06F 3/00

(52) U.S. Cl. 725/46; 725/34; 725/35; 725/9

(57) ABSTRACT

A system, apparatus, and method are provided for generating broadcast schedules and potential content based on aggregated user profile information comprising user preferences and content ratings. According to one embodiment of the present invention, users may access a website to create user profiles that include content preferences and content ratings. A broadcast operations center may then use the information to generate content selection, mix, and/or broadcast scheduling.

### COPYRIGHT NOTICE

Contained herein is material that is subject to copyright protection. The copyright owner has no objection to the facsimile reproduction of the patent disclosure by any person, as it appears in the Patent and Trademark Office patent files or records, but otherwise reserves all rights to the copyright whatsoever.

### FIELD OF THE INVENTION

This invention relates to content broadcasting, in general, and more specifically to content broadcasting using broadcast schedules based on user profiles.

### BACKGROUND OF THE INVENTION

Many attempts have been made to allow a broadcast data services subscriber (user) to receive only the information the user wants to receive. However, many of the methods and apparatus available today primarily rely on providing users with digital and/or paper guides to choose programs of their choice. Such methods and apparatus further rely on the expectation that the broadcast schedule is convenient for at least most of the users. Because today's broadcast schedules are generally based on popularity surveys of a program, the broadcasters often use an unnecessary amount of bandwidth to broadcast the content even to those users who are not available at the time, or are not interested in the content.

Typically, a user uses a standard paper guide, e.g., TV Guide, or a local newspaper to see when his or her favorite program will be broadcast. Such paper guides list programs by date, time, and channel. A user has no choice but to watch and/or listen to his or her favorite program at the time of broadcast, or tape the program using a recording device, such as Video Cassette Recorder (VCR) or Personal Video Recorder (PVR), for later viewing and/or listening. Further, such paper guides only rate a program based on popularity surveys and expert ratings, such as Nielson Ratings, and therefore, do not necessarily reflect an individual's or community's core preferences/interests.

Moreover, many cable providers and satellite dish providers provide electronic television guides (electronic guides), which are accessible with a click of a remote control button. However, as with the paper guides, the electronic guides provide a list of programming with a predetermined broadcast time, date, and channel. The user would have to be available at a scheduled time to watch and/or listen to the program or tape it for later viewing. Further, the broadcast schedules are based on popularity surveys and expert ratings, and may not reflect an individual's or a community's preferences/interests. Currently, there are some websites, e.g., Amazon.com, that allow users to create accounts or list preferences for future use. However, such information is used by the websites to provide recommendations. For example, Amazon.com recommends books, music, etc., based on a user's past purchases or another user's purchases who bought the same or similar product. No website available today collects information from users, aggregates such information, allows the users to rate potential content ahead of time, and then makes this aggregated source of information available to a broadcast operations center for use in connection with performing content selection and broadcast scheduling.

### BRIEF DESCRIPTION OF THE DRAWINGS

The appended claims set forth the features of the invention with particularity. The invention, together with its advantages, may be best understood from the following detailed description taken in conjunction with the accompanying drawings of which:

FIG. 1 is a block diagram of a typical computer system upon which one embodiment of the present invention may be implemented;

FIGS. 2A, 2B, and 2C are block diagrams illustrating prior art broadcast systems;

FIG. 3 is a block diagram conceptually illustrating an overview of a broadcasting network for providing broadcast scheduling based on user profiles, according to one embodiment of the present invention;

FIG. 4 is a flow diagram conceptually illustrating a process overview of broadcast scheduling based on user profiles, according to one embodiment of the present invention;

FIG. 5 is a block diagram conceptually illustrating broadcast scheduling based on user profiles, according to one embodiment of the present invention;

FIG. 6 is a flow diagram conceptually illustrating a process of broadcast scheduling based on user profiles, according to one embodiment of the present invention;

FIG. 7 is a block diagram conceptually illustrating broadcast scheduling based on user profiles using a feedback system, according to one embodiment of the present invention;

FIG. 8 is a flow diagram conceptually illustrating a process of broadcast scheduling based on user profiles using a feedback system, according to one embodiment of the present invention.

### DETAILED DESCRIPTION

A method and apparatus are described for providing broadcast scheduling using user profiles. Broadly stated, embodiments of the present invention allow users to influence content selection, content mix, and/or broadcast scheduling.

A system, apparatus, and method are provided for generating broadcast schedules and potential content based on aggregated user profile information comprising user preference data and content rating data. According to one embodiment of the present invention, users may access a website to generate a user profiles that include content preference data and content rating data. A broadcast operations center may then use the information to generate content selection, mix, and/or broadcast scheduling.

According to one embodiment, a website is provided to allow a community of users to initialize and develop user profiles. A user may access the website and provide user preference data and content rating data. Such information may be used to generate a user profile corresponding to the user. Aggregated user profile information may then be provided to the broadcast operations center where it is employed to generate a playlist and a broadcast schedule. Finally, the content is broadcast to the community of users according to the playlist and the broadcast schedule.

According to another embodiment, a feedback mechanism may be employed for dynamically tailoring and optimizing user profiles based upon content usage and interaction information. For example, the receivers and/or the website may monitor and/or track a user's usage pattern and dynamically update the user profile to produce an improved profile. The feedback information gathered at the receivers may be periodically transferred over a feedback channel to the website. The aggregated improved profiles may then be used to generate content selection and mix for future broadcast schedules. According to another embodiment, the feedback mechanism may allow a user to manually update the user profile by accessing the website.

In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention includes various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

The present invention may be provided as a computer program product that may include a machine-readable medium, having stored thereon instructions which may be used to program a computer (or other electronic devices) to perform a process according to the present invention. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, the present invention may also be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, a carrier wave or other propagation medium shall be regarded as comprising a machine-readable medium for the purpose of the present specification.

Importantly, while embodiments of the present invention will be described with reference to viewers and streaming video, the apparatus and methods described herein are equally applicable to various other types of media and multimedia. For example, viewers and/or listeners may receive steaming audio and video, streaming audio, text, graphics, animation, data, and the like.

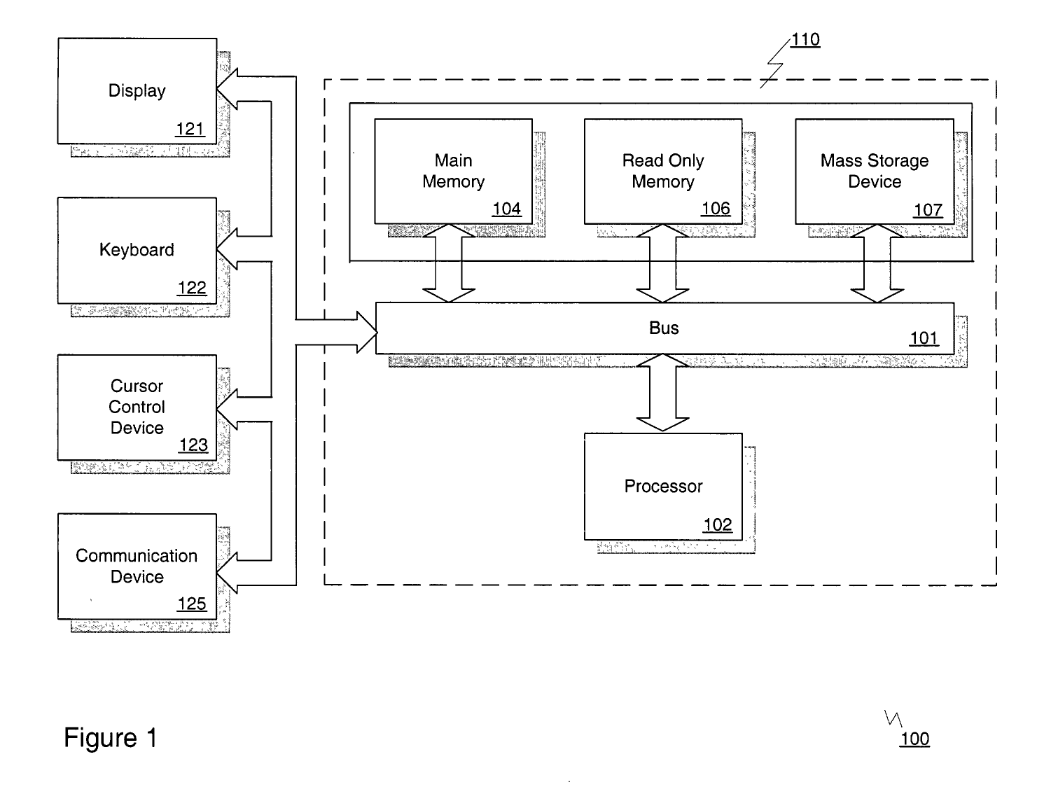

FIG. 1 is a block diagram of a typical computer system upon which one embodiment of the present invention may be implemented. Computer system 100 comprises a bus or other communication means 101 for communicating information, and a processing means such as processor 102 coupled with bus 101 for processing information. Computer system 100 further comprises a random access memory (RAM) or other dynamic storage device 104 (referred to as main memory), coupled to bus 101 for storing information and instructions to be executed by processor 102. Main memory 104 also may be used for storing temporary variables or other intermediate information during execution of instructions by processor 102. Computer system 100 also comprises a read only memory (ROM) and/or other static storage device 106 coupled to bus 101 for storing static information and instructions for processor 102.

A data storage device 107 such as a magnetic disk or optical disc and its corresponding drive may also be coupled to computer system 100 for storing information and instructions. Computer system 100 can also be coupled via bus 101 to a display device 121, such as a cathode ray tube (CRT) or Liquid Crystal Display (LCD), for displaying information to an end user. Typically, an alphanumeric input device 122, including alphanumeric and other keys, may be coupled to bus 101 for communicating information and/or command selections to processor 102. Another type of user input device is cursor control 123, such as a mouse, a trackball, or cursor direction keys for communicating direction information and command selections to processor 102 and for controlling cursor movement on display 121.

A communication device 125 is also coupled to bus 101. The communication device 125 may include a modem, a network interface card, or other well-known interface devices, such as those used for coupling to Ethernet, token ring, or other types of physical attachment for purposes of providing a communication link to support a local or wide area network, for example. In this manner, the computer system 100 may be coupled to a number of clients and/or servers via a conventional network infrastructure, such as a company's Intranet and/or the Internet, for example.

It is appreciated that a lesser or more equipped computer system than the example described above may be desirable for certain implementations. Therefore, the configuration of computer system 100 will vary from implementation to implementation depending upon numerous factors, such as price constraints, performance requirements, technological improvements, and/or other circumstances.

It should be noted that, while the steps described herein may be performed under the control of a programmed processor, such as processor 102, in alternative embodiments, the steps may be fully or partially implemented by any programmable or hard-coded logic, such as Field Programmable Gate Arrays (FPGAs), transistor-transistor logic (TTL) logic, or Application Specific Integrated Circuits (ASICs), for example. Additionally, the method of the present invention may be performed by any combination of programmed general-purpose computer components and/or custom hardware components. Therefore, nothing disclosed herein should be construed as limiting the present invention to a particular embodiment wherein the recited steps are performed by a specific combination of hardware components.

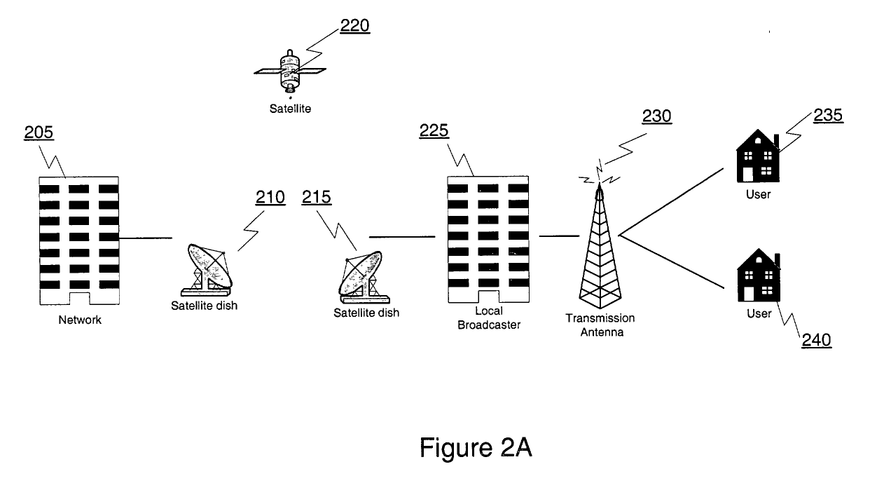

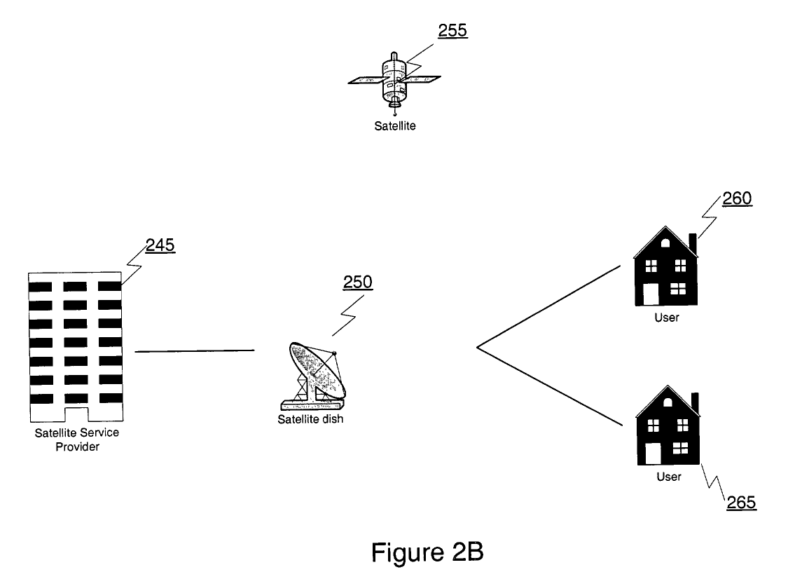

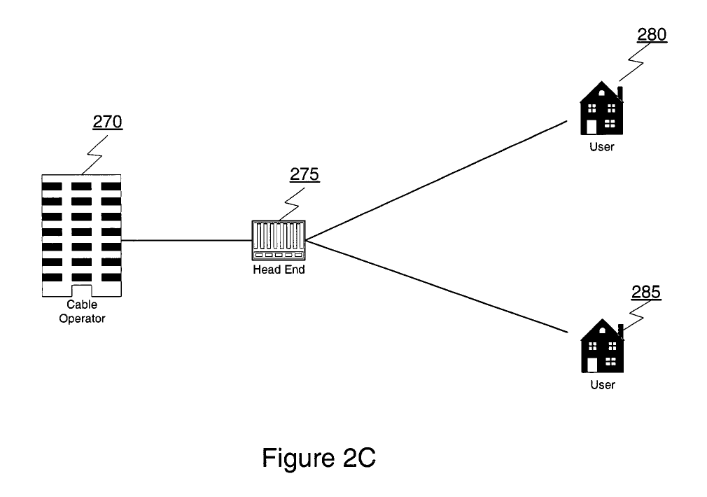

FIGS. 2A, 2B, and 2C are block diagrams illustrating prior art broadcast systems. As illustrated in FIG. 2A, a network 205, such as ABC or NBC, provides content to a local broadcaster 225, such as KABC or KNBC, via a satellite system 210-20. The local broadcaster 225 may provide its own content, along with the network's 205 content, to users 235-40, using a transmission antenna 230. The transmission antenna 230 transmits the content through the atmosphere. The users 235-40 receive the content being broadcast by the local broadcaster 225 in cooperation with the network 205. The local broadcasters 225 and/or the networks 205 selectively generate broadcast schedules based on popularity surveys and expert ratings.

FIG. 2B illustrates a satellite service provider 245, such as Dish Network or DirectTV, providing content to users 260-65 via a satellite system 250-55. In such a system, the users 260-65 may have a receiving satellite dish of their own to receive the content provided by the satellite service provider 245. The satellite service provider 245 provides content in cooperation with the networks 205 and local broadcasters 225. The network 205 and local broadcaster 225 generate content, and provide it to the users 260-65 via the satellite service provider 245. As mentioned with regard to FIG. 2A, broadcast schedules are primarily generated by the networks 205 and/or the local broadcasters 225, and occasionally, by the satellite service providers 245, based on popularity surveys and expert ratings.

FIG. 2C illustrates another prior art broadcast system having a cable operator/provider 270, such as AT&T or Comcast Cable, providing content to users 280-85. In this case, the cable operator 270 provides content to the users 280-85 in cooperation with the network 205 and local broadcaster 225. Cable operators/providers 270 often require strategically located head-ends 275 to provide content to their users 280-85. As it relates to FIGS. 2A and 2B, broadcast schedules are chosen primarily by the networks 205 and/or local broadcasters 225, and occasionally, by the cable operators 270.

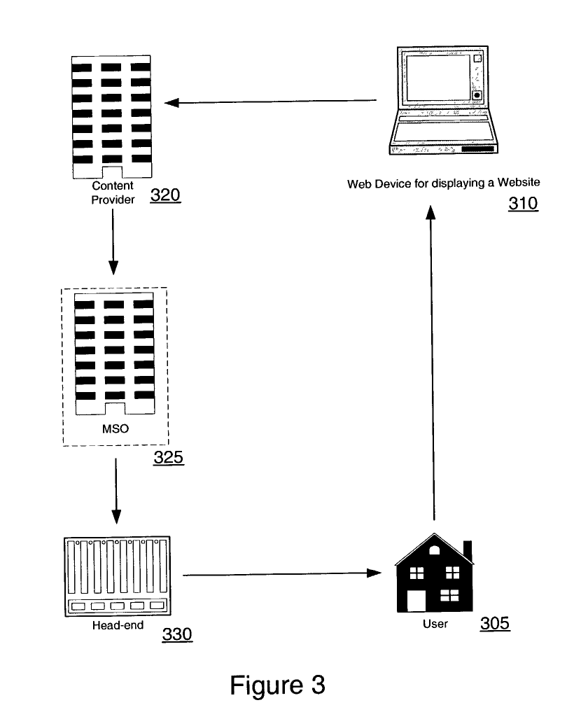

FIG. 3 is a block diagram that conceptually illustrates a broadcasting network feedback loop that allows users to influence content scheduling, content mix, and/or broadcast scheduling for providing broadcast schedules based on user profiles, according to one embodiment of the present invention. As illustrated, the broadcasting network 300 may comprise a website 310 for a user 305 to provide user preferences and content ratings by accessing the website 310 via the Internet. A user profile may then be generated by based on the user preferences and content ratings. A content provider or a broadcast operations center 320 may tailor and optimize the user profile to generate a playlist and a broadcast schedule. The playlist and the broadcast schedule may then be provided to a Multiple Systems Operator (MSO) 325 for forwarding it to a head-end 330 associated with the user 305. The head-end 330 may broadcast the content to the user 305, according to the playlist and the broadcast schedule, via a receiver.

According to one embodiment of the present invention, content providers and MSOs may be physically and/or logically integrated. For example, when integrated, the content provider 320 may physically include the MSO 325, and may also perform its functions, such as providing playlists and broadcast schedules to various head-ends 330.

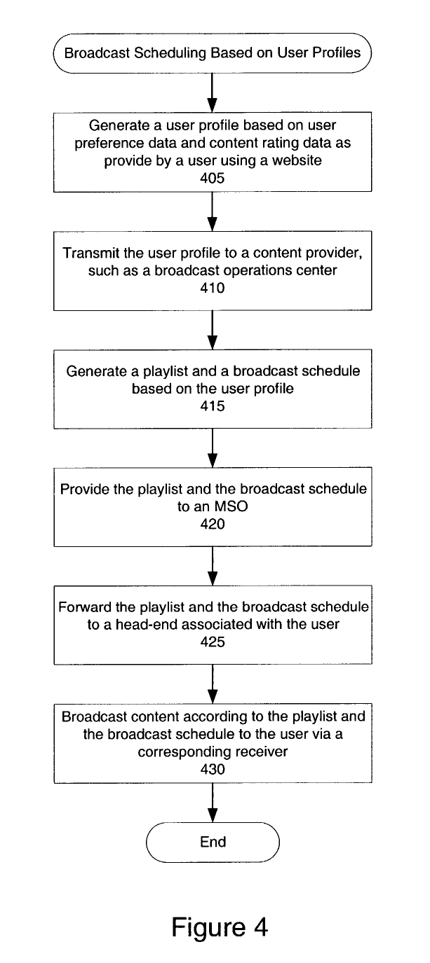

FIG. 4 is a flow diagram conceptually illustrating a process overview of broadcasting content based on user profiles, according to one embodiment of the present invention. First, a user profile is generated using a website based on user preferences and content ratings as provided by a user by accessing the website in processing block 405. The user profiles generated on the website are then transmitted to a content provider or a broadcast operations center for further processing in processing block 410. The broadcast operations center processes the information received from the website to generate a playlist and a broadcast schedule by tailoring and optimizing the user profile based on the user preferences and/or content ratings information for the user in processing block 415. According to one embodiment, the playlist and the broadcast schedule are provided to an MSO in processing block 420. The MSO may forward the information to a regional head-end associated/corresponding with the user in processing block 425. According to another embodiment, the MSO may be physically and/or logically integrated with the content provider; hence, the content provider may perform functions usually performed by the MSO. The head-end broadcasts the content to the user, according to the playlist and the broadcast schedule, via a receiver or the like in processing block 430.

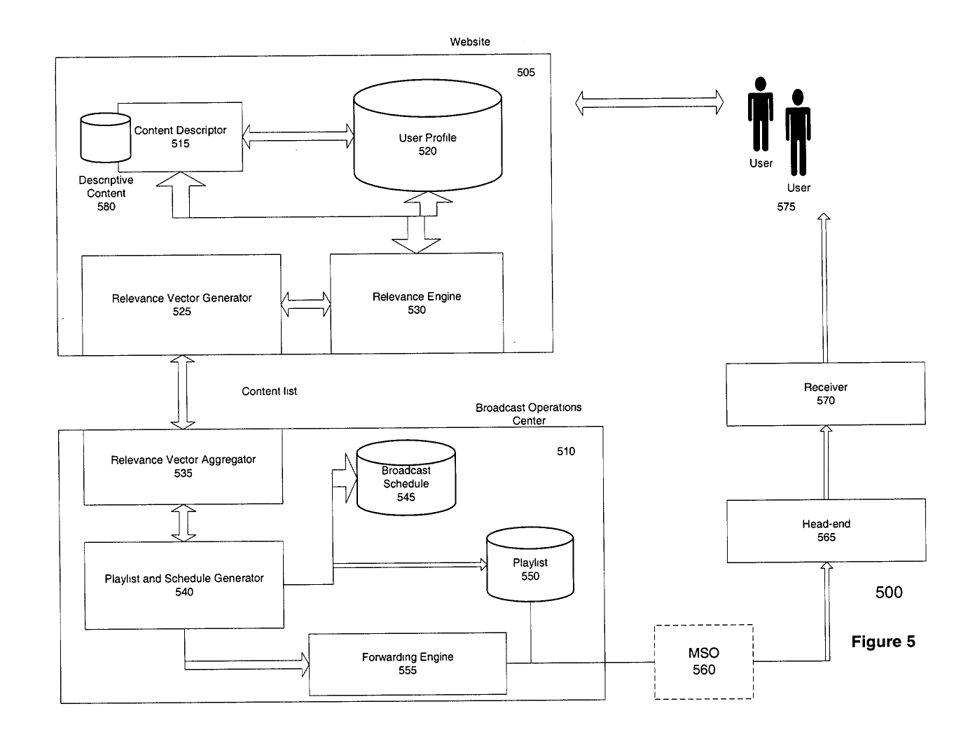

FIG. 5 is a block diagram conceptually illustrating broadcast scheduling based on user profiles, according to one embodiment of the present invention. A website 505, which may work as a community center, is established for users 575 to access for establishing user profiles by providing user preferences and content ratings. Users 575 may access the website 505 via the Internet to provide their user preferences and content ratings. For example, a user 575 may log in by first identifying him/herself with an email address or account identification (already provided to the user 575), such as an account number, userID, or password, or a combination of all. Once logged in for the first time, the user 575 may setup an initial user profile 520 by filling out an on-line form containing a few questions.

According to one embodiment of the present invention, the user 575 may be of any form of user desired for a particular implementation, and it is to be interpreted broadly. For example, the user 575 may be an individual in a household, an individual set-top box may represent the user 575, a community of users 575 based on households, head-ends, cable systems, zip codes, or other geographic locations, and the user 575 may choose to join a community because of the content they may receive. However, the user 575 may also be defined as a community (of one user 575), and therefore, the words “community” and “user” may be synonymous.

According to one embodiment, once the initial user profile 520 is setup, the user 575 may access his/her corresponding user profile 520 to provide user preference data and content rating data. The user profile 520 may correspond to a single user 575, a family including the user 575, a device associated with or corresponding to the user 575, a business including the user 575, a demographic segment (e.g., age, education level, gender) including the user 575, or a geographic location (e.g., Beverly Hills, Calif., or 90210) associated with or corresponding to the user 575.

According to one embodiment, the user profile 520 may include user information (e.g., characteristics and attributes of the user 575, billing information, address), content preference information indicating types of content (e.g., movies, sports) and characteristics of content (e.g., blockbusters or action movies) that the user 575 prefers, timing preference information indicating when the user prefers to receive or consume the content, observational profile information based on automated observation and profile recordation of content consumption behavior of the user 575 and/or direct contribution of profile data by the user 575, and rating information indicating favorable (or unfavorable) ranking and rating of a particular content (e.g., the user 575 rating “the Shawshank Redemption” as four stars out of a possible four stars). According to one embodiment, the profile may contain information or data operable to differentiate or identify desired or preferred content from undesired or un-preferred content.

According to one embodiment, the content may be of any form of content desired for a particular implementation, and is to be interpreted broadly. For example, the content may be computer software or multimedia, such as, various types of programs, movies, videos, videos on demand, video games, audio, MP3 audio, and other types of content, such as structured data. Furthermore, the content may have a digital format and digital processing, and may be used on the content including storage, electronic manipulation, perfect copying, compression, transmission, and others. For example, an identical copy of the digital content may be created and a bit-wise comparison of the original and the copy may be used to verify that the two are identical.

The content may be in an electronically accessible format. Typically, the content will exist as a computer file having a particular file format that is compatible, standard, or efficient for the type of content and will be stored in a memory. For example, in the case of audio content, the file format may be an MP3 format and the content may be stored in a memory representing an audio library. However, other embodiments are contemplated. For example, according to one embodiment, the digital content may exist as a stream of digital data. The stream of digital data may be provided by a digital data generating device (e.g., a digital camera/recorder), may be provided by an electronically connected source or provider (e.g., a news feed or a stock ticker), or may be provided by another functionally connected entity.

Once the user profile 520 is setup, the user 575 may experience the content in the form of trailers, advertisements, etc., in order to rate such content. The rating of the content may be performed both actively and passively. For example, according to one embodiment, the user 575 may elect to interact with the website 505 using the GUI elements on the screen to rate the content experienced. However, according to another embodiment, the user 575 may chose not to actively rate the content, in which case the system 500 may automatically rate the content for the user 575. For example, the system 500 may track the number to times, e.g., five times, the user 575 watched a movie trailer, and based on that information, the system 500 may assume that the user 575 likes the movie. According to one embodiment, the website 505 may comprise a personalization or relevance engine 530 to keep track of the user's 575 activities and rate the content accordingly. The user 575 may, however, actively amend the passive rating conducted by the system 500, by simply accessing the user profile 520 and performing the task manually. For example, the system 500 may rate a movie at two stars, because the user watched the trailer of the movie five times. The user 575, however, may access the user profile 520 and lower the rating to zero or one star or increase it to three or four stars. According to another embodiment, there may not be any content rating.

According to one embodiment, the rating systems may be implemented in a number of ways, and should be interpreted broadly. For example, number of stars (such as one through four), numbers (such as 1 through 10), letters (such as A through D), words (such as Good, Bad, and Fair), or symbols (such as bulls and bears; thumbs up and down) may be used, or any combination of such may be used, to rate the content.

According to one embodiment, the user 575 may provide user preferences in addition to rating the content. The user 575 may enter information, such as indicating the content, time, and channel number/name that the user 575 prefers. For example, the user in Denver may indicate that s/he likes watching the NBC show “Ed” at 7:00 p.m. on Saturdays on available channel 99, instead of watching the show on Wednesdays at 7:00 pm. on channel 9.

According to one embodiment, the website 505 may comprise a content descriptor 515, which may comprise content descriptors based on metadata vocabulary. The content descriptor 515 may associate the content descriptors with the content for providing description to the content. The descriptive content 580 may contain content that is descriptive in nature as indicated, such as, by attributes and characteristics of the content, content transmission time, the manner in which the content may be transmitted, and other related data. Typically, the content descriptors are separate from the actual portion of the content that is entered by users, although other embodiments are contemplated, such as those where the descriptive content is sampled, from within the presented content. For example, the descriptive content 580 may indicate content type (e.g., movie, sitcom, mini-series, news, music, sports), content category (e.g., baseball, comedy, action, science fiction, horror, jazz, blues), content subject matter (e.g., Los Angeles Dodgers, economics, politics, travel), and other information.

According to one embodiment, the website 505 may comprise a relevance engine 530 for determining the relevance of the descriptive content 580. The relevance engine 530 may be an algorithmic and heuristic software system for evaluating the descriptive content 580 for relevance to the users 575. The input into the relevance engine 530 may include the descriptive content 580, its associated metadata content descriptors 515 as relevance vectors, and user profiles 520. The output out of the relevance engine 530 may include the relevance score, and ordered lists of content, or playlists, with relative ranking corresponding to the users 575 based on the user profiles 520. A Playlist may be a set of content that get played out on a network as a unit, and a content descriptor 515 describing the set of content. The content provider may compose the playlist before it is played out on a given network. Additionally, the relevance engine 530 may have a rules processor to fine tune the recommended playlists by analyzing other information, such as the frequency at which the users 575 may have watched certain content, profitability of a set of content relative to another set of content from the perspective of a service provider (based information, such as contract term), recommending a program which may be similar to the one frequently watched by the user 575.

According to one embodiment, the relevance engine 530 may periodically compare the descriptive content 580 with user preferences and content ratings being received from the users 575. The comparison is to be interpreted broadly to include the ones mentioned, and those that will be apparent to those skilled in the art. For example, the comparison may be based on corresponding keywords or unique identifiers, such as “X Redemption” (for the Shawshank Redemption), where the “X” is the unique identifier. The unique identifier X may be both in the descriptive content 580 and user profile 520. By comparing the unique identifiers, the relevance engine 530 may compare the user profile 520 with the descriptive content 580, and label the movie as relevant. According to one embodiment, the system 500 may employ a first plurality of keywords (e.g., including drama, prison, Stephen King), the user profile 520 may contain a second plurality of keywords (e.g., including fiction, prison), and the relevance engine 530 may determine that the first plurality and the second plurality are sufficiently similar to label the Shawshank Redemption as relevant. The relevance of the descriptive content 580 may change with the updating of the user preferences and content ratings. The relevant content may then be transmitted to the relevance vector generator 525 to generate a content list based on the relevance of the content.

According to one embodiment, the relevance vector generator 525 may interact with the relevance engine 530 in order to constantly receive the most relevant content. The relevance vector generator 525 may generate vectors based on the relevance of the content as determined by the relevance engine 530. The relevance vectors may be a set of key-value pairs that define a piece of content. The relevance vectors may also be viewed as refined content descriptors 515 relating to a given piece of content, providing an intelligent description and/or rating of the content. For example, a relevance vector may refine a content descriptor to provide an objective measure, such as 5 on a scale of 1-5, relating to the content, such violence, of a movie, such as Natural Born Killers has violent content in it is metadata about the movie. A set of relevance vectors may be generated for each piece of content so that the relevance engine 530 and/or other components of the system 500 may use such relevance vectors in their algorithms.

According to one embodiment, a relevance vector may be based on genre of movies, e.g., historical, family, horror, or on frequency of requests, or on content rankings as entered by the users 575. These vectors may be listed in the order of relevance to influence the future playlist and broadcast schedule generation by the operation center 510. Broadcast schedule, or Program Information Guide, may be a transmission schedule, created by associating a playlist with the transmission policy of the system 500, which may be based on, but not limited to, the users' preferences and/or content event. Once the vectors are generated, the relevance vector generator 525 may transmit the information to the operation center 510 for further processing. It is contemplated that the website 505 and the broadcast operations center 510 may be in the same place, physically, however, separated logically, or integrated both physically and logically.

The broadcast operations center 510 may receive the content list based on the relevance of the content from the website 505 for further processing. The relevance vector aggregator 535 may aggregate the content list based on content relevance and bandwidth availability. The aggregated content may then be transmitted to the playlist and schedule generator 540. The playlist and schedule generator 540 may generate a playlist and a broadcast schedule corresponding to each user using the content received from the relevance vector aggregator 535. The playlists and broadcast schedules generated by the playlist and schedule generator 540 may remain in effect, until either a new set of content is received or there is a change in the relevance of the current content, which may require updating of user profiles. According to one embodiment, both the playlists and broadcast schedules may remain stored 545, 550 for possible future use. The playlist and schedule generator 540 may periodically interact with both the broadcast schedule storage 545 and the content/playlist storage 550 for keeping the data updated at all times.

The newly generated playlists and broadcast schedules are transmitted to the forwarding engine 555 for forwarding of the information from one network node to another. For example, the forwarding engine 555 may forward the playlists and broadcast schedules to the respective MSOs 560 for delivery to the users 575. According to one embodiment, the MSOs 560 are, or are similar to, cable providers having a subscriber list of the users 575. An MSO 560 after receiving the playlists and broadcast schedules from the broadcast operations center 510 may forward the information to various head-ends 565 for user delivery. It is, however, conceivable and is contemplated that the MSO 560 and the broadcast operations center 510 may be a single entity both physically and logically, or integrated physically, but separated logically, or integrated logically, but separated physically, or separated altogether. In case of a logical integration, there may not be a need for an MSO, as the broadcast operations center may act as an MSO and perform its functions.

According to another embodiment, the playlists and broadcast schedules may be forwarded by the forwarding engine 555 directly to the head-ends 565 without the benefit of the MSOs 560. The forwarding engine 555 may be aware of the bundling of the content that needs to get to the head-ends 565, and may typically determine the time required to send the content to the head-ends 565 for proper delivery to the users 575. The forwarding engine 555 may also work out the staging of the content at the head-end-level based on the broadcast schedules corresponding to each of the users 575. The head-ends 570 ultimately broadcast the content according to the broadcast schedules to the corresponding receivers 570.

According to one embodiment, the users 575 may access their respective receivers 570 to access the content based on and matching their previously submitted user profiles 520. According to one embodiment, a receiver 570 may be part of a content reception system to receive the content. The receiver 570 may be interfaced to receive a content containing signal, a decoder to decode the signal, a memory to store the content, and a processor to execute instructions, such as instructions to determine that the content has been received. For example, without limitation, the receiver 570, the decoder, the memory, the processor, and/or the instructions may be included in a computer system, a personal computer, a digital television having a memory and a processor, a set-top box, a personal video recorder, a sound system having a memory and a processor, or other systems. The content reception system may comprise an antenna (e.g., rabbit ears, satellite dish, etc.). The content reception system may have different levels of intelligence, as desired, such as intelligence to know how to connect and receive the content (e.g., tune to a particular channel to receive a corresponding predetermined broadcast transmission) and to have the intelligence to receive and use a schedule of broadcast (e.g., to use a conceptual TV guide of sorts).

Depending on a particular implementation, the content reception system may or may not include a content presentation system (e.g., a digital television) that is capable of presenting the digital content in a human consumable format (e.g., as video presented on a display device). According to one embodiment, the content reception system may include a content presentation system to directly present the content to the users 575. For example, the content reception system may include a digital television, a personal video recorder, a stereo, an MP3 player, a CD ROM burner, or another content presentation subsystem. Alternatively, the content reception system may not include a content presentation system. The content reception system may present the content to a recipient content presentation system that is functionally, electrically, and/or physically coupled with the content reception system that presents the content to the users 575, including viewers and listeners.

According to one embodiment, conventional technologies may be used, together with any desirable modifications that will be apparent to those skilled in the art. For example, the system 500 may comprise a conventional processor to execute instructions, a conventional memory to store content, a conventional encoder to encode content, a conventional transmitter to transmit a content containing signal, a conventional receiver to receive the content containing signal, and a conventional decoder to decode content. Without limitation, the content may be converted to an MPEG format, transmitted via a tower antenna over an atmospheric communication medium, received by an antenna, and converted from the MPEG format to an uncompressed useable format.

According to one embodiment, the system 500 may comprise a content transmission system to transmit the content and a content reception system to receive the content. The term “transmission” and related terms will be used broadly to refer to moving data, frequently digital data, from one place or system to another and the term “reception” and related terms will be used broadly to refer to accepting the moved data. Typically, transmission may include generating and submitting a content-containing machine-accessible signal and receiving will include accepting and interpreting the content-containing machine-accessible signal. For example, a transmission tower may broadcast an electromagnetic radiation content-containing signal simultaneously to multiple receiving antennas (e.g., rabbit ear antennas) operable to accept the signal. Alternatively, rather than broadcasting, the signal may be narrowcast to specific recipients, similarly to the way cable television is delivered to cable subscribers.

According to one embodiment, the content transmission system may transmit the content over a substantially one-way communication link, in which the predominant or only transmission is from the content transmission system to a content reception system. According to one embodiment, the link may be bi-directional, although typically, the link will be a substantially non-client-server link. A client-server link would be typified by the content reception system issuing a request for the content and the content transmission system then issuing the content in response, similar to the way a web page may be received using the Internet. In contrast, in a non-client-server link, the content transmission system may provide the content without the request. That is, the content transmission system may transmit content to the content reception system, and typically a plurality of other content reception systems simultaneously, without receiving a specific request that is processed and responded to or supplied.

According to one embodiment, the link may be a link that is shared by multiple content reception systems such as the described content reception system. The link may be based on a number of technologies, including satellite dish, fiber optic, coaxial cable, and others. For example, the link may be a one way broadcast pipe in which the content is simultaneously broadcast to all of the receivers 570 connected with a network (e.g., having an antenna like rabbit ears or a satellite dish to receive the transmission) or narrowcast to a select group of receivers (e.g., having authorization to receive the transmission). For example, the link may carry a digital TV channel with a bandwidth of 19.39 megabits per second and may be partitioned among multiple channels such as four channels that each carry 4.85 megabits per second, which may carry either content or re-transmitted content.

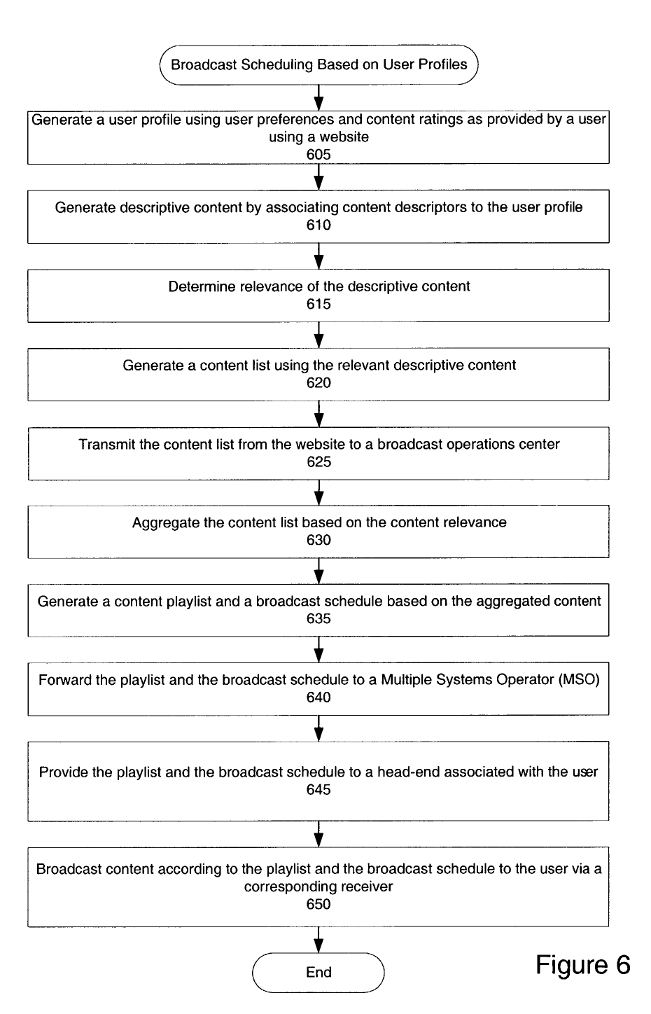

FIG. 6 is a flow diagram conceptually illustrating a process of broadcast scheduling based on user profiles, according to one embodiment of the present invention. First, a user profile is generated based on user preferences and content ratings as provided by a user using a website in processing block 605. Content descriptors based on metadata vocabulary, are associated with the user profile in order to associate description to the content of the user profile in processing block 610. The relevance engine of the website determines the relevance of the descriptive content based on the user profile in processing block 615. The personalization engine of the relevance vector generator generates a list of all the relevant descriptive content in terms of content relevance based on content ratings provided by the user in processing block 620. The list is transmitted to a broadcast operations center for further processing in processing block 625.

The relevance vector aggregator of the broadcast operations center aggregates the list of relevant content in accordance with the relevance of the content corresponding to each user in processing block 630. The playlist and schedule generator generates a content playlist and a broadcast schedule for the user to be used later to broadcast the content based on the playlist and the broadcast schedule in processing block 635. According to one embodiment, the playlist and the broadcast schedule generated by the playlist and schedule generator are transmitted to the forwarding engine of the broadcast operations center to forward the information to an MSO in processing block 640. The MSO distributes the playlist and the broadcast schedule to the head-end associated with the user in processing block 645. According to one embodiment, the MSO and the broadcast operations center may be physically and/or logically integrated. The head-end broadcasts the content according to the playlist and the broadcast schedule to the user via a corresponding receiver in processing block 650.

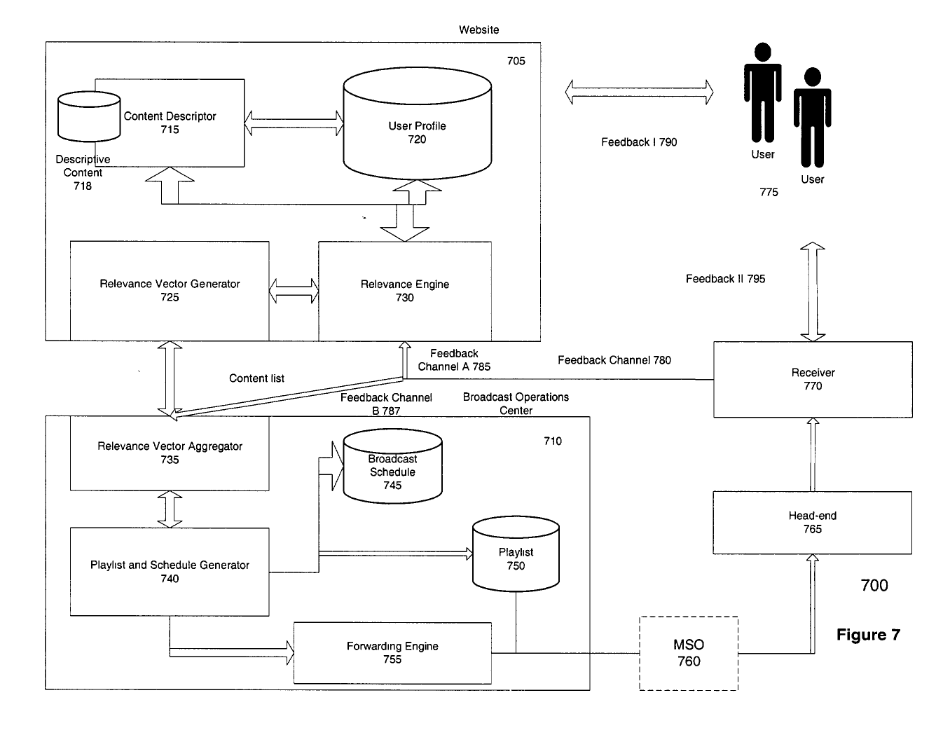

FIG. 7 is a block diagram conceptually illustrating broadcast scheduling based on user profiles using a feedback system, according to one embodiment of the present invention. According to one embodiment, as illustrated, a user 775 may actively provide feedback, feedback I 790, by accessing the user profile 720 stored on the website 705. The user 775 may access the user profile 720 to enter feedback I 790 by, but not limited to, rating the content received, based on the existing user profile, via the receiver 770. The user 775 may also provide feedback relating to user preferences for updating the existing user profile. In case of any overlapping content information, the system 700 may update the user profile 720 with the most current content information entered by the user 775. Further, the user 775 may also manually update and/or amend the existing user profile 720 to influence future broadcast scheduling.

According to another embodiment, the user 775 may actively provide feedback, feedback II 795, by accessing a receiver 770, such as a set-top box. For example, the user 775 may input feedback II 795 into the set-top box 770 using a remote control or keyboard. The receiver 770 may be linked with the rest of the system 700 via a feedback channel 780. The feedback channel 780 may have an extension, feedback channel A 785, to link the receiver 770 with the website 705. The receiver 770 may periodically, or as necessary, provide the user's feedback to the website 705, where, for example, the relevance engine 730 of the website 705 may use the feedback to determine and update content relevance corresponding to the user 775.

According to one embodiment, the receiver 770 may also be linked to the broadcast operations center 710, via another feedback channel 780 extension, feedback channel B 787. The receiver 770 may periodically, or as necessary, provide the user's feedback to the broadcast operations center 710, where, for example, the relevance vector aggregator 735 may update the aggregated information based on the feedback received.

According to one embodiment, the feedback forwarded by the receiver 770 to the website 705 and/or to the broadcast operations center 710 may be based on the information passively tracked by the receiver 770, as opposed to actively provided by the user 775. In other words, the user 775 may not actively provide the feedback, but instead the receiver 770 may observe the user's 775 pattern. The user 775 may choose not to actively enter any feedback information into the receiver 770 and/or the website 705, but instead, let the receiver 770 observe the user's 775 pattern to automatically compile a feedback and dynamically update the compiled feedback. The observing of the user's pattern may be based on a predetermined criteria set by the user 775, or by the system 700, or by any other participating authority. The receiver 770 may observe the user pattern continuously or periodically as predetermined, collect the related information, compile a feedback, and provide the feedback to either the website 705 or the broadcast operations center 710, based on the predetermined criteria or as required by the circumstances.

According to one embodiment, any combination of the feedback system is contemplated, and may be used based on a given circumstances or predetermined criteria. It is also contemplated that not all the channels and/or links are necessary, and several other channels and links may be added, as it will be obvious to the one familiar with the art. For example, the feedback system may completely be eliminated, or only manual feedback system be provided for the user 775 to actively input feedback information by accessing the website 705.

The communication link linking the receiver 770 with the website 705 or the broadcast operations center 710 may not need much bandwidth if only used to transmit the feedback. The link may forward the feedback affordably, without expensive, bulky, or otherwise undesirable transmission systems. The link may be one-way or bi-directional, as desired. Other desirable qualities for the link of certain embodiments may include existing availability to many residences and businesses, ease of installation or activation, low cost per unit bandwidth. According to one embodiment, the link may make use of a wire-based link available at a business or residence associated with the content reception system. For example, the link may be based on a telephone line, coaxial cable, a cable line, all types of digital subscriber lines (xDSL), and others. The link may also be wireless, such as via cellular telephone, Very Small Aperture Terminal (VSAT), and others.

Typically, the content will be transmitted and re-transmitted over the communication link to the website 705 and/or the broadcast operations center 710. However, their may be another authority add to store and/or analyze the feedback. Further, according to one embodiment, the content transmission system may include novel software instructions to interpret the feedback and to transmit the content based on the feedback. The software instructions may comprise transmission instructions that interpret the feedback.

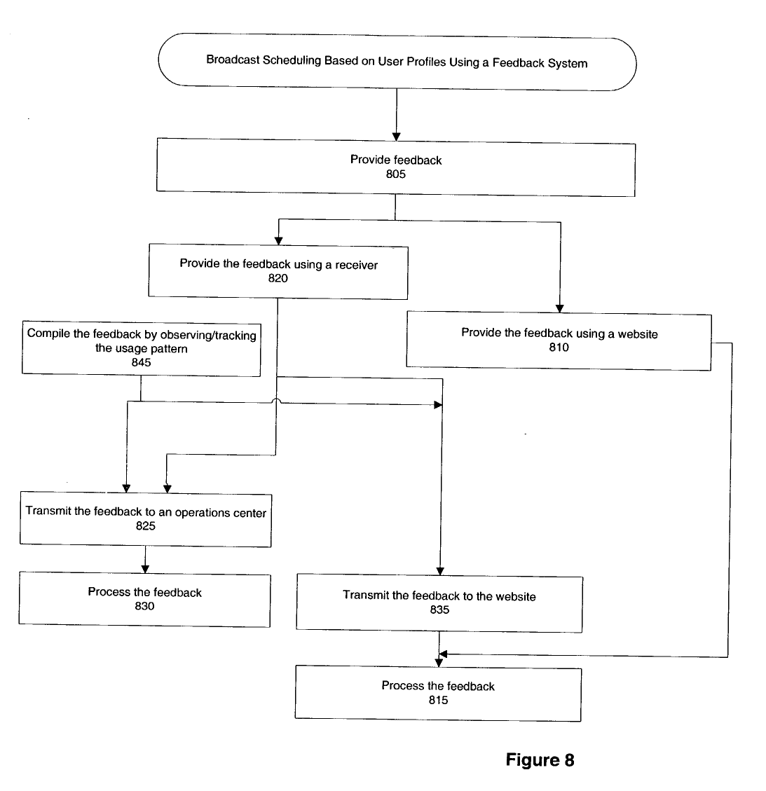

FIG. 8 is a flow diagram conceptually illustrating a process of broadcast scheduling based on user profiles using a feedback system, according to one embodiment of the present invention. First, the user may provide feedback in processing block 805. According to one embodiment, the user may choose to enter the feedback into a website by directly accessing the user profile in processing block 810. The website then processes the feedback information and dynamically updates the user profile in processing block 815. According to another embodiment, the user may choose to provide the feedback information by accessing a receiver in processing block 820. The receiver then may forward the feedback to the website using a feedback channel via a network link in processing block 835. The feedback is then processed by the website in processing block 815. The receiver may also choose to forward the feedback to a broadcast operations center in processing block 825. The broadcast operations center then processes the feedback and dynamically updates the user information, such as user profile, in processing block 830. The feedback used to update the user profile produces improved user profile. A future playlist and a future broadcast schedule are generated based on the improved user profile. A future broadcast of content is formed and provided to the user based on the future playlist and the future broadcast schedule.

According to one embodiment, the receiver may automatically observe the user's usage pattern, and compile a feedback without any input from the user in processing block 840. After compiling the feedback, the receiver may forward the feedback to the website in processing block 835, or to the broadcast operations center in processing block 825, for further processing in processing blocks 815 and 830 respectively.

What is claimed is:

1. A method comprising:
generating a plurality of user profiles corresponding to a plurality of users, wherein the plurality of user profiles comprise user preference data and content rating data; and
generating a playlist and a broadcast schedule by aggregating the plurality of user profiles; and
broadcasting content to the plurality of users according to the playlist and the broadcast schedule.

2. The method of claim 1, wherein the user preference data and content rating data are provided by the plurality of users.

3. The method of claim 1, further comprising:
generating descriptive content by associating content descriptors to the plurality of user profiles, wherein the content descriptors are based on metadata dictionary; and
compiling a plurality of relevance content lists corresponding to the plurality of users by comparing the descriptive content to the plurality of user profiles.

4. The method of claim 1, wherein the plurality of users comprises a community of users.

5. The method of claim 4, wherein the community of users is based on, but not limited to, the following: demographics, geographic locations, and head-ends.

6. The method of claim 1, wherein the user preference data comprises content and broadcasting time as preferred by the plurality of users.

7. The method of claim 1, wherein the content rating data comprises content based on the interest-level of the plurality of users and as rated by the plurality of users using the following: alphabets, numbers, and symbols.

8. The method of claim 1, further comprising receiving feedback to dynamically update the plurality of user profiles to a plurality of improved user profiles.

9. The method of claim 8, wherein the receiving feedback comprising:
receiving active feedback as provided by the plurality of users using a website; and
receiving passive feedback as compiled by a plurality of receivers corresponding to the plurality of users by observing usage pattern of the plurality of users.

10. The method of claim 3, wherein the compiling the plurality of relevance lists is based on relevance of content according to the plurality of user profiles.

11. The method of claim 9, wherein the observing usage pattern comprises tracking the frequency at which each of the plurality of users experiences the content.

12. The method of claim 10, wherein the relevance of the content is determined by a predefined criteria based on the following: frequency at which the content is experienced by the plurality of users and the interest-level of the plurality of users.

13. A method comprising:
generating a plurality of user profiles corresponding to a plurality of users, wherein the plurality of user profiles comprise user preference data and content rating data;
generating a playlist and a broadcast schedule by aggregating the plurality of user profiles;
broadcasting content to the plurality of users according to the playlist and the broadcast schedule;
receiving feedback by tracking usage pattern of the plurality of users; and
updating the plurality of user profiles based on the feedback to produce a plurality of improved user profiles.

14. The method of claim 13, further comprising:
generating a future playlist and a future broadcast schedule by aggregating the plurality of improved user profiles; and
broadcasting content to the plurality of users according to the future playlist and the future broadcast schedule.

15. The method of claim 13, wherein the receiving feedback by tracking usage pattern of the plurality of users is passive feedback.

16. The method of claim 13, further comprises receiving active feedback, wherein active feedback is provided by the plurality of users.

17. A broadcast scheduling system comprising:
a website to generate a plurality of user profiles corresponding to a plurality of users, wherein the plurality of user profiles comprise user preference data and content rating data;
a broadcast operations center wirelessly linked to the website, wherein the broadcast operations center is to generate a playlist and a broadcast schedule by aggregating the plurality of user profiles;
a Multiple Systems Operator (MSO) coupled with the broadcast operations center linking the broadcast operations center with a plurality of head-ends; and
a plurality of head-ends coupled with a plurality of receivers corresponding with a plurality of users, wherein the plurality of head-ends is to receive the playlist and the broadcast schedule from the MSO and to broadcast content to the plurality of users via the plurality of receivers according to the playlist and the broadcast schedule.

18. The broadcast scheduling system of claim 17, wherein the website provides the plurality of user profiles to the broadcast operations center to generate the playlist and the broadcast schedule.

19. The broadcast scheduling system of claim 17, wherein the plurality of receivers is further to track usage pattern of the plurality of users to generate feedback corresponding to the plurality of users.

20. The broadcast scheduling system of claim 17, wherein the website is further to:
receive the feedback from the plurality of receivers;
update the plurality of user profiles based on the feedback to produce a plurality of improved user profiles; and
provide the plurality of improved user profiles to the broadcast operations center to generate the playlist and the broadcast schedule.

21. The broadcast scheduling system of claim 17, wherein the broadcast operations center is further to:
generate a future playlist and a future broadcast schedule by aggregating the plurality of improved user profiles; and
broadcast content to the plurality of users according to the future playlist and the future broadcast schedule.

22. The broadcast scheduling system of claim 17, wherein the MSO is to receive the playlist and the broadcast schedule from the broadcast operations center and to forward the playlist and the broadcast schedule to the plurality of head-ends to broadcast content to the plurality of users according to the playlist and the broadcast schedule.

23. The broadcast scheduling system of claim 19, wherein the plurality of receivers comprise a content presentation sub-system.

24. The broadcast scheduling system of claim 19, wherein the plurality of receivers comprise a content reception sub-system.

25. A machine-readable medium having stored thereon data representing sequences of instructions, the sequences of instructions which, when executed by a processor, cause the processor to:
generate a plurality of user profiles corresponding to a plurality of users, wherein the plurality of user profiles comprise user preference data and content rating data; and
generate a playlist and a broadcast schedule by aggregating the plurality of user profiles; and
broadcast content to the plurality of users according to the playlist and the broadcast schedule.

26. The machine-readable medium of claim 25, wherein the user preference data and content rating data are provided by the plurality of users.

27. The machine-readable medium of claim 25, wherein the sequences of instructions which, when executed by the processor, further cause the processor to:
generate descriptive content by associating content descriptors to the plurality of user profiles, wherein the content descriptors are based on metadata dictionary; and
compile a plurality of relevance content lists corresponding to the plurality of users by comparing the descriptive content to the plurality of user profiles.

28. A machine-readable medium having stored thereon data representing sequences of instructions, the sequences of instructions which, when executed by a processor, cause the processor to:
generate a plurality of user profiles corresponding to a plurality of users, wherein the plurality of user profiles comprise user preference data and content rating data;
generate a playlist and a broadcast schedule by aggregating the plurality of user profiles;
broadcast content to the plurality of users according to the playlist and the broadcast schedule;
receive feedback by tracking usage pattern of the plurality of users; and
update the plurality of user profiles based on the feedback to produce a plurality of improved user profiles.

29. The machine-readable medium of claim 28, wherein the sequence instructions which, when executed by the processor, further cause the processor to:
generate a future playlist and a future broadcast schedule by aggregating the plurality of improved user profiles; and
broadcast content to the plurality of users according to the future playlist and the future broadcast schedule.

30. The machine-readable medium of claim 28, wherein to receive feedback by tracking usage pattern of the plurality of users is passive feedback.
